(19) United States
(12) Patent Application Publication
(10) Pub. No.: US 2014/0020583 A1
(43) Pub. Date: Jan. 23, 2014

(54) ADAPTABLE IMPRESSION DRUM

(71) Applicant: Avi BARAZANI, Ness Ziona (IL)

(72) Inventor: Avi BARAZANI, Ness Ziona (IL)

(21) Appl. No.: 13/550,734

(22) Filed: Jul. 17, 2012

(51) Int. Cl. B41F 21/04

(52) U.S. Cl. 101/246

(57) ABSTRACT

An adaptable impression drum configurable to handle either B1 or B2 sized substrates in a manner utilizing the majority of available circumferential surface area of the drum body.

### BACKGROUND

Typically impression drums employed by offset printing systems are configured to hold a single substrate during each printing cycle. Printing operations of either B1 or B2 sized substrates commonly employ an impression drum having a single gripper mechanism and circumferential surface area capable of accommodating the entire length of B1 sized substrates.

### BRIEF DESCRIPTION OF THE DRAWINGS

Examples are described in the following detailed description and illustrated in the accompanying drawings in which:

FIG. 1 is a schematic, side view of an offset printing arrangement including an offset cylinder and an adaptable impression drum, according to an example;

FIG. 2A is a schematic, side view of a gripper mechanism with a pivotal gripper jaw in an open state for receiving a substrate for printing, according to an example;

FIG. 2B is a schematic, side view of a gripper mechanism with a pivotal gripper jaw in an closed state for holding substrate during printing, according to an example;

FIG. 3A is a schematic, top view of the gripper mechanism in an actuated, open state and an actuator mechanism, according to an example;

FIG. 3B is a schematic, top view of the gripper mechanism in an a non-actuated, closed state and an actuator mechanism, according to an example;

FIG. 4 is a schematic, side view of an adaptable impression drum being adapted for printing B1 sized substrate, according to an example;

FIG. 5 is a schematic, side view of an adaptable impression drum configured for printing B1 sized substrate; according to an example;

FIG. 6 is a schematic, side view of an adaptable impression drum being adapted for printing B2 sized substrate, according to an example; and

FIG. 7 is a schematic, side view of an adaptable impression drum configured for printing B2 sized substrate; according to an example.

It will be appreciated that elements may not be drawn to scale and reference numerals may be repeated in different figures to indicate corresponding or analogous elements.

### DETAILED DESCRIPTION

The adaptable impression drum is directed to increasing holding capacity and versatility by enabling printing at full production capacity of either B1 or B2 sized substrates.

A drum body of an impression drum may have a first recess in which a first gripper mechanism is permanently mounted and a second recess which may receive either a recess cover for printing B1 substrates or a second gripper mechanism for printing B2 sized substrates.

The recess cover may be constructed from metallic, plastic, hard rubber, or a combination of these materials, according to examples.

The following terms will be used throughout this document:

“Impression drum” or “Impression drum system” refers to an overall unit including drum body and associated gripper mechanisms and recess covers. Typically, the impression drum is a cylinder on which the substrate being printed is held when receiving ink from an ink carrier, like an offset cylinder. Standard circumference of B1 impression drum is about 1100 mm for portrait fed B1 sheets, according to an example.

“Drum body” refers to the primary cylindrical element of the impression drum to which the gripper mechanisms and recess covers are mounted. It should be appreciated that the “drum wall” or “drum body wall” all refer to the same component.

“Seam” refers to the area on the drum body occupied by a gripper mechanism that reduces surface area available for supporting a substrate during printing along about 100 mm of the circumference.

“B1” refers to a substrate having as standard a length of 1000 mm and a width of 707 mm, according to examples.

“B2” refers to a substrate having as standard a length of 707 mm and a width of 500 mm, according to examples.

The diameter of an impression drum designed to handle B1 or B2 sized substrates would therefore be about 350 mm, according to examples.

“Substrate” refers to a sheet onto which ink is being applied during a printing cycle. Examples may include paper, cardboard, plastic, metal or other flexible sheet material capable of receiving ink.

“Gripper mechanism” refers to a mechanism configured to hold a substrate on the impression drum, according to examples.

“Flex tabs” refer to a releasable connection arrangement in which stiff, but flexible, tabs of one body engage corresponding slots or protuberances of a second body so as to hold both bodies together until disengagement.

Although examples are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, may refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

It should be appreciated that in certain examples, impression drums having sizes other than those used for B1 substrates may also be adapted as described herein to double holding capacity.

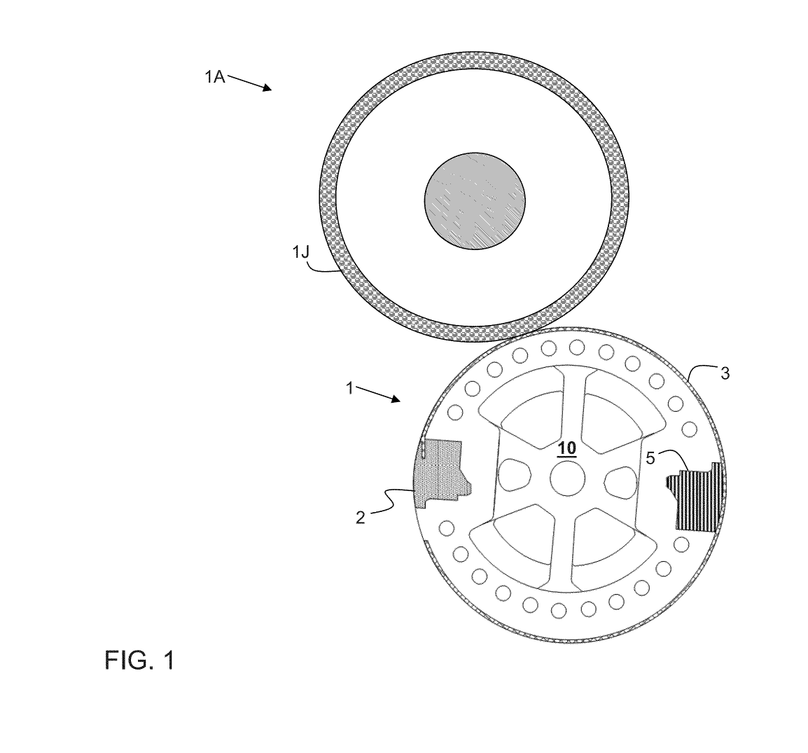

Turning now to the figures, FIG. 1 is a schematic side view of an offset cylinder 1A in rolling contact with impression drum 1 commonly used in offset printing. As shown, offset cylinder 1A includes a polymeric rubber blanket 1J from which ink is received from a plate cylinder (not shown) and transferred to substrate 3 held or supported by drum body 10 of adaptable impression drum 1. Specifically, adaptable impression drum 1, includes a first gripper mechanism 2 mounted in a dedicated recess disposed in drum body 10, and a recess cover 5 for covering a second recess. It should be noted that the recesses are currently obscured by the elements mounted within them.

In operation, ink is transferred from a plate cylinder to the substrate 3 held on the adaptable impression drum 10 by way of the intermediary offset cylinder 1A to protect the surface of the plate cylinder from excessive wear due to friction with the substrate 3 during printing and to ensure uniform application of ink to substrates having irregularities normally interfering with a application of ink.

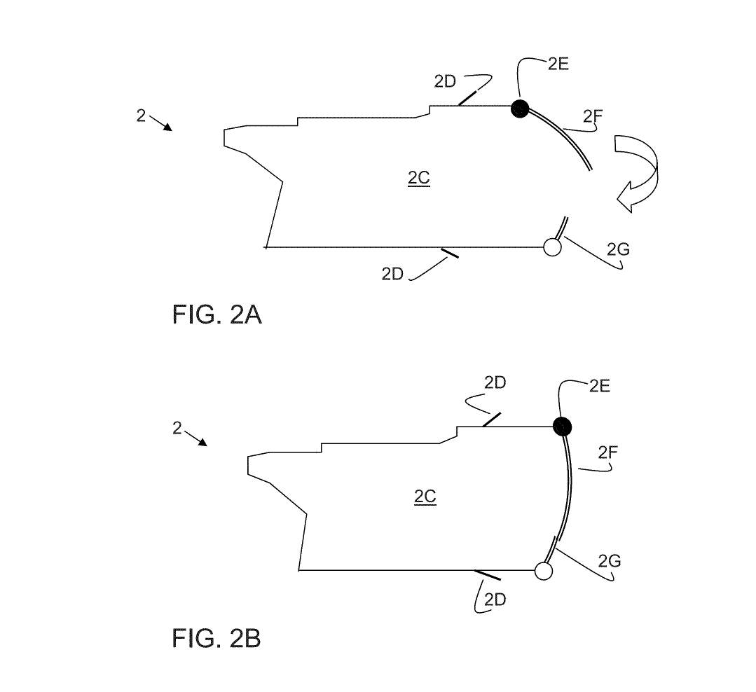

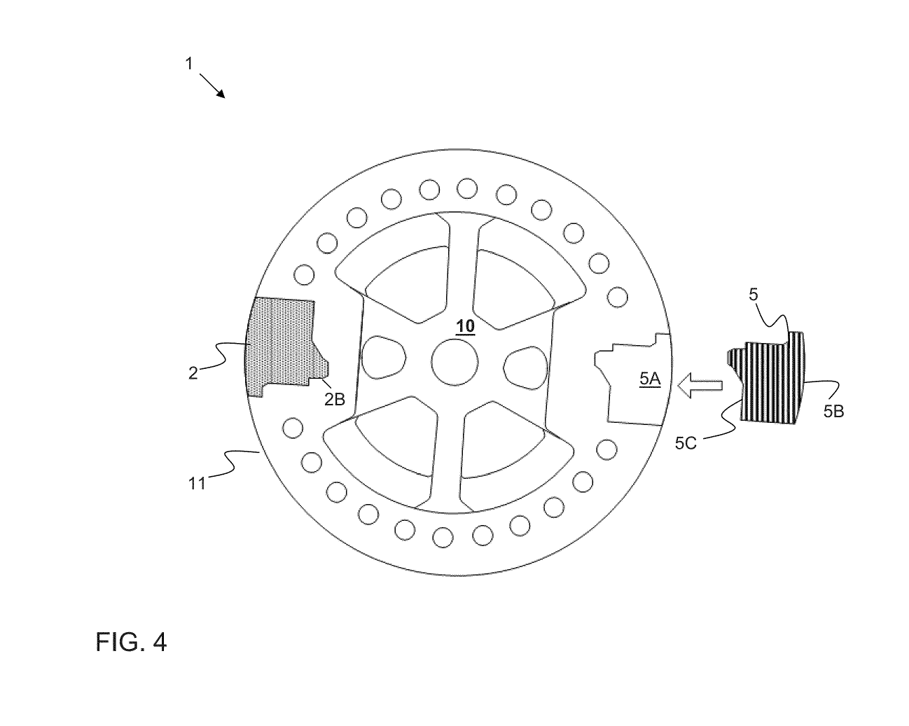

FIG. 2A depicts a side view of gripper mechanism 2 including gripper casing 2C, pivotal jaw 2F pivotally mounted to shaft 2E, static jaw 2G and engagement tabs 2D for mounting, in an example. As shown, pivotal jaw 2F may be disposed in an open state to receive a substrate. Casing 2C may be constructed from metallic materials, hard plastic, rubber or a combination of them. Engagement tabs 2D extend outwardly from casing 2C and engage corresponding slots or protuberances disposed in the walls of the recess 5A disposed in drum body (see FIG. 4).

FIG. 2B depicts the gripper mechanism of FIG. 2A in which the pivotal jaw 2F is disposed in a closed position to hold a substrate between pivotal and static jaws 2F and 2G, respectively, according to an example. It should be appreciated that gripper mechanism 2, may be permanently mounted in impression drum 1 except for maintenance needs in which it may released from drum wall 10 and replaced.

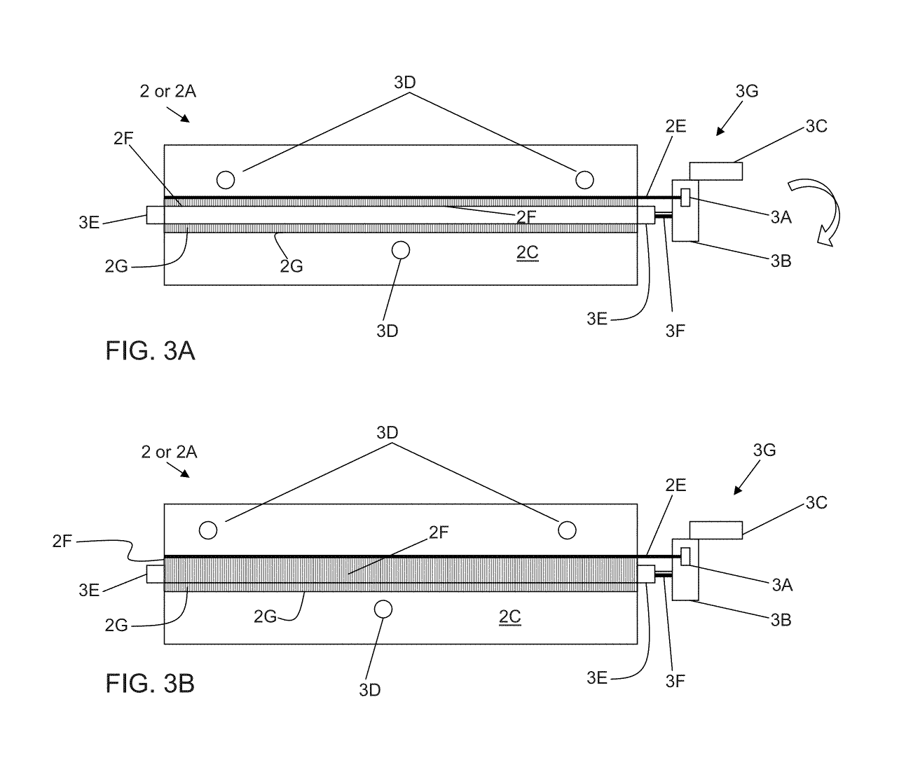

FIG. 3A depicts a top view of either gripper mechanism 2 or 2A together with a motorized actuator system 3G for actuating pivotal jaw 2F. As noted above, pivotal jaw 2F is pivotally mounted on shaft or axle 2E. Shaft 2E is linked to cam follower 3A in communication with cam 3B so that pivotal jaw may be actuated, i.e. opened, as cam follower 3A encounters the eccentricities of cam 3B, according to an example.

Cam 3B is itself mounted on a cam shaft 3F rotationally mounted within impression drum axle 3E so that cam 3B can either rotate or remain stationary as impression drum 1 rotates. The discrepancy between the angular velocity of impression drum 1 and cam 3B defines the periodicity of gripper jaw actuation, according to an example. Cam rotation rate is defined by variable speed cam motor 3C whose speed may be set in accordance to the desired timing of gripper actuation. For example, printing operations requiring substrates to be held on impression drum throughout four revolutions necessitate that the difference between the angular velocity of impression drum 1 and cam 3B is such that for every four revolutions of impression drum 1, cam follower 3A encounters cam eccentricity one time, according to an example

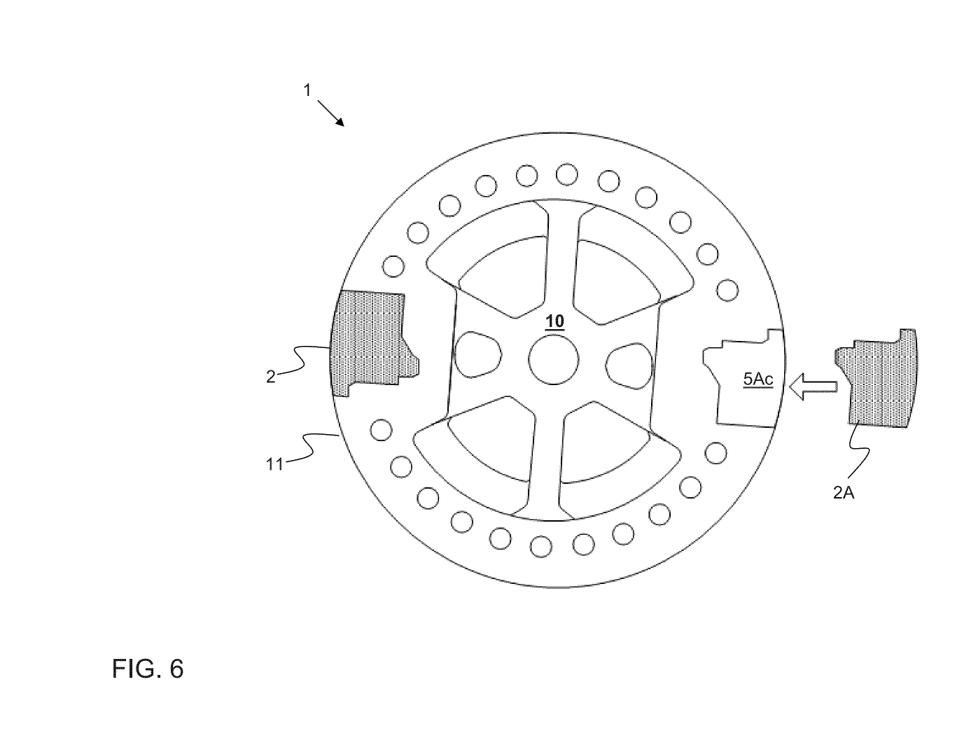

FIG. 3B depicts gripper mechanism 2 having pivotal jaws 2F after rotating into a closed state; bearing against static jaw 2G. It should be noted that this particular example configuration is based on pivotal jaw 2F being resiliently biased to assume a closed position so that only when cam follower 3A encounters cam eccentricity pivotal jaw 2F opens. Both FIGS. 3A and 3B depict mounting bores 3D traversing gripper casing 2C for receiving mounting bolts that screw into corresponding holes disposed in the walls of recesses 2B and 5A, thereby holding gripping mechanism 2 and 2A securely to drum body 10 as shown in FIG. 6.

It should be appreciated that during printing operations employing only gripper mechanism 2, the motorized actuator system 3G of second gripper mechanism 2A remains idle, according to an example.

FIG. 4 is a schematic, side view of adaptable impression drum 1 being adapted for printing of B1 sized substrates. As noted previously, adaptable impression drum 1, includes drum body 10 having a dedicated recess 2B in which a first gripper mechanism 2 is permanently mounted. Furthermore, the adaptable impression drum 1 may include a second recess 5A disposed in the drum body 10 for receiving recess cover 5. Recess cover 5, may have an arcuate outer surface 5B substantially matching a contour of the walls of the drum body 10 so as to provide substantially seamless support to B1 sized substrates supported by the majority of the drum body 10, according to an example. Recess cover 5 may also possess a drum contact surface 5C having multiple surfaces to abut against corresponding surfaces disposed in drum body 10 to facility stability and a secure connection during printing operations.

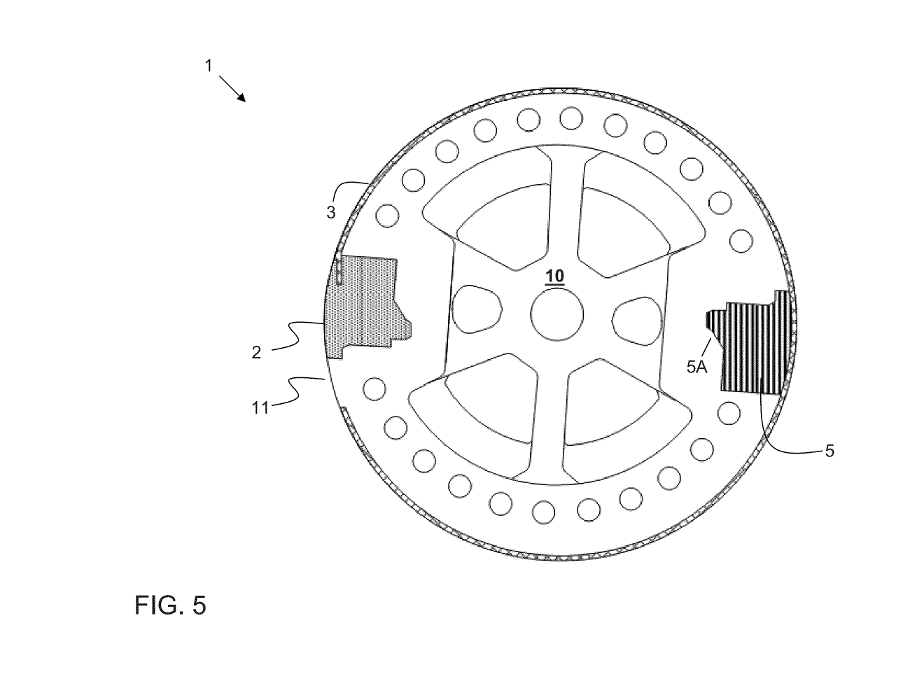

FIG. 5 is a schematic, side view of an adaptable impression drum fully adapted for printing B1 sized substrate in which recess cover 5 is securely mounted in, now obscured, second recess 5A of drum body 10. The circumferential support surface is now augmented by arcuate outer surface 5B whose curvature substantially matches that of circumferential surface area 11, as noted above. B1 sized substrate encircling drum body 10 is supported by both by circumferential surface area 11 of drum body 10 and also by arcuate surface 5B, according to examples.

It should be appreciated that recess cover 5 may be constructed of a material providing the necessary substrate support during printing operations (e.g. metallic, rubber, plastic material or a combination thereof). Furthermore, recess cover 5 may be mounted and removed manually according to the printing requirements and may be secured to drum body 10 by any appropriate attachment configuration; like mounting bolts or flex tabs for example.

FIG. 6 depicts drum body 10 being configured to efficiently handle B2 sized substrates in a manner utilizing the majority of circumferential surface area 11. As shown, recess cover 5 has been removed from second recess 5A in drum body 10 and a second gripper mechanism 2A is being mounted in its place. It should be appreciated that the same attachment configurations and mounting method employed to mount recess cover 5 may also be used to mount second gripper mechanism 2A, according to an example.

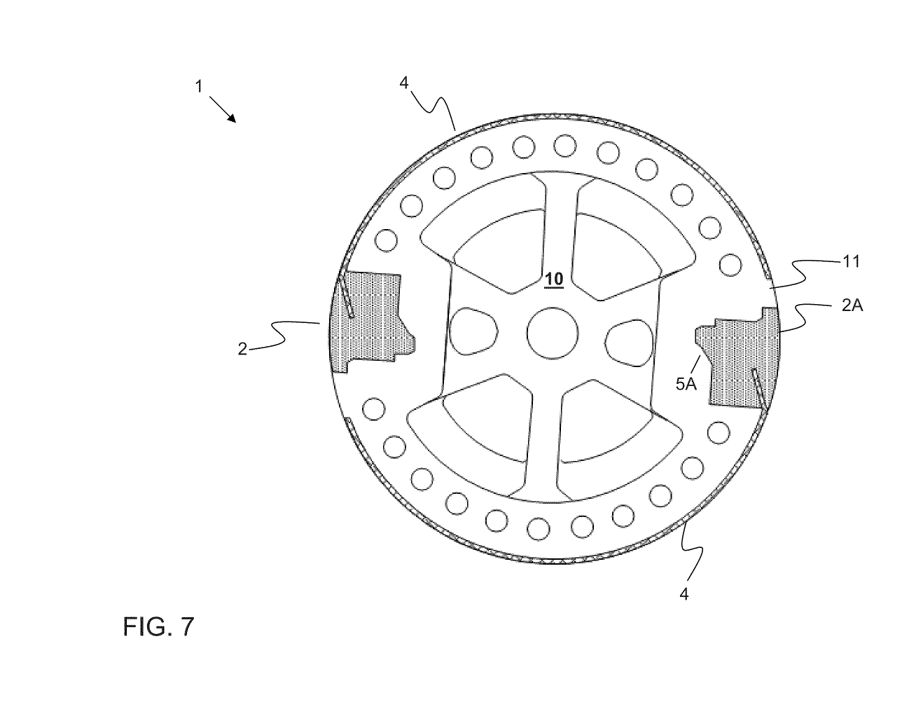

FIG. 7 depicts impression drum 1 after conversion from B1 printing to B2 printing in which second gripper mechanism 2A has been securely mounted in, now obscured, second recess 5A in drum body 10. Gripper mechanisms 2 and 2A may both hold a B2 sized substrate during each printing cycle in a manner providing the required circumferential support surface 11 for each substrate.

Impression drum 1 may be re-configured to handle B1 sized applications by simply reversing the process; i.e. replace second gripper mechanism 2A with recess cover 5.

What is claimed is:

1. An adaptable, impression drum system for use in printing operations, the system comprising:
a drum body having a drum wall, the drum wall having a first recess and a second recess;
a first gripper mechanism mounted in the first recess; and
a recess cover releasably mountable in the second recess of the drum wall.

2. The system of claim 1, wherein the recess cover has an arcuate surface substantially matching a contour of the drum wall.

3. The system of claim 1, wherein the recess cover includes an attachment configuration selected from the group consisting of mount bolts and flex tabs.

4. The system of claim 1, wherein the recess cover is constructed from a material selected from the group consisting of metal, rubber, and plastic.

5. The system of claim 1, further comprising a second gripper mechanism releasably mountable in the second recess of the drum wall

6. The system of claim 4, wherein the second gripper mechanism includes an attachment configuration selected from the group consisting of mount bolts and flex tabs.

7. The system of claim 1, the wherein the wherein the drum body is rotationally linked to an offset cylinder.

8. The system of claim 5, wherein each of the first and the second gripper mechanisms include a motorized actuator system.

9. An adaptable offset printing system comprising:
an offset cylinder,
an adaptable, impression drum system in rotational communication with the offset cylinder, the impression drum having a drum body including a first recess and a second recess;
a first gripper mechanism mounted in the first recess; and
a recess cover releasably mountable in the second recess.

10. The system of claim 9, wherein the recess cover has an arcuate surface substantially matching a contour of wall of the drum body.

11. The system of claim 1, further comprising a second gripper mechanism releasably mountable in the second recess.

12. The system of claim 11, wherein the second gripper mechanism is linked to a motorized actuator system.

13. The system of claim 11, wherein the motorized actuator system is configured to assume an idle state during printing operations employing only the first gripper mechanism.

14. A method for adapting an impression drum for printing of different sizes, the method comprising:
providing a drum body having a first gripper mechanism mounted in a first recess disposed in the drum body and a second gripper mechanism disposed in a second recess disposed in the drum body;
removing the second gripper mechanism from the second recess; and
mounting a recess cover in the second recess.

15. The method of claim 14, wherein the recess cover is constructed from a material selected from the group consisting of metal, rubber, and plastic.

16. The method of claim 14, wherein the recess cover includes a connection configuration selected from the group consisting of mount bolts and flex tabs.

17. The method of claim 14, the wherein second gripper mechanism includes a connection configuration selected from the group consisting of mount bolts and flex tabs.

18. The method of claim 14, the wherein the wherein the drum body includes has a diameter of about 350 mm.

19. The method of claim 14, the wherein the wherein the drum body is rotationally linked to an offset cylinder.

20. The method of claim 14, the wherein each of the first and the second gripper mechanism include a motorized actuator system.
